(19) United States
(12) Patent Application Publication
(10) Pub. No.: US 2008/0168487 A1
(43) Pub. Date: Jul. 10, 2008

(54) Software-based conditional access to IPTV content

(75) Inventors: Lee Chow, Naperville, IL (US); Adam Klein, Cedar Park, TX (US); Stephen Rys, Austin, TX (US); Timothy Thomas Gronkowski, Chicago, IL (US)

Correspondence Address: SCHWEGMAN, LUNDBERG & WOESSNER, P.A., P.O. BOX 2938, MINNEAPOLIS, MN, 55402, US

(73) Assignee: AT&T Knowledge Ventures, L.P.

(21) Appl. No.: 11/651,256

(22) Filed: Jan. 8, 2007

(51) Int. Cl. H04N 7/167

(52) U.S. Cl. 725/31

(57) ABSTRACT

Systems and methods receive data representing geographic areas and blackout events. The data is used by a software module in an IPTV system to determine whether content is to be provided to subscribers.

### FIELD

This application relates to systems and methods for content distribution, and more specifically to systems and methods for providing software-based conditional access to content.

### BACKGROUND

Content providers deliver content via broadcasts to a number of users and/or deliver content via on-demand processing based on requests received and content availability. Content providers who have not negotiated broadcast rights for specific programming in certain geographical regions are obligated to restrict access or blackout the content in particular geographical areas. Content providers commonly provide alternative or substituted content that may be shown in areas where the primary content has been blacked out. A content provider typically encrypts and multiplexes the primary and alternative content in channels for transmission to various cable head ends. These signals are demultiplexed and transmitted to integrated receiver decoders (IRDs) which decrypt the content.

A control stream indicates which virtual channels are broadcast to different geographic areas. There is typically one IRD per channel (or group of similar channels) for each geographic area. The content providers typically have a mapping of the unique identifier of each IRD within the service provider's network to the serving area for each of the IRDs. The content provider creates virtual networks or groups of IRDs based on the IRD serving areas. The IRDs decrypt the signals and prepare the output streams, while simultaneously using the virtual network and virtual channel indicators in the control stream to distribute the output stream. During a blackout, the IRDs switch from one virtual channel to another based on retune messages from the content provider. This causes a simultaneous substitution of content on a specific channel. Note that each cable headend is statically assigned to serve a geographic region, with the IRDs dedicated to each cable headend.

In conventional systems, a blackout areas are defined on a channel by channel basis, and are also defined by specifying a particular IRD. Thus customers served with content that is received by the IRD will receive alternative or substituted content.

Two issues arise from the above described architecture. First, numerous IRDs are required to implement a blackout. There is an IRD per channel (or group of similar channels) per geographic area defined as a blackout area. Second, the level of granularity for defining a blackout area is limited to an area served by an IRD. In many cases, an IRD per channel is used for an entire city or metropolitan area. Thus the level of granularity may be no smaller than the entire city or metropolitan region created by specifying a particular IRD as a blackout area.

### BRIEF DESCRIPTION OF DRAWINGS

Embodiments are illustrated by way of example and not limitation in the figures of the accompanying drawings, in which like references indicate similar elements and in which:

FIG. 1 is a block diagram of a system for geographically restricting content in accordance with an example embodiment.

FIG. 2 is a flowchart illustrating a method in accordance with an example embodiment for providing geographically restricted content.

FIG. 3 is a sequence diagram for a method for provisioning geographically restricted content for a content provider in accordance with an example embodiment.

FIG. 4 is a sequence diagram for a method for defining a blackout schedule for geographically restricted content in accordance with an example embodiment.

FIG. 5 is a sequence diagram for a method for updating a blackout schedule for geographically restricted content in accordance with an example embodiment.

FIG. 6 is a sequence diagram for a method for deleting a blackout schedule for geographically restricted content in accordance with an example embodiment.

FIG. 7 is a sequence diagram for a method for verifying a blackout schedule for geographically restricted content in accordance with an example embodiment.

FIG. 8 illustrates a diagrammatic representation of machine in the example form of a computer system within which a set of instructions, for causing the machine to perform any one or more of the methodologies discussed herein, may be executed.

### DETAILED DESCRIPTION

In the following description, for purposes of explanation, numerous specific details are set forth in order to provide a thorough understanding of an embodiment of the present invention. It will be evident, however, to one skilled in the art that the present invention may be practiced without these specific details.

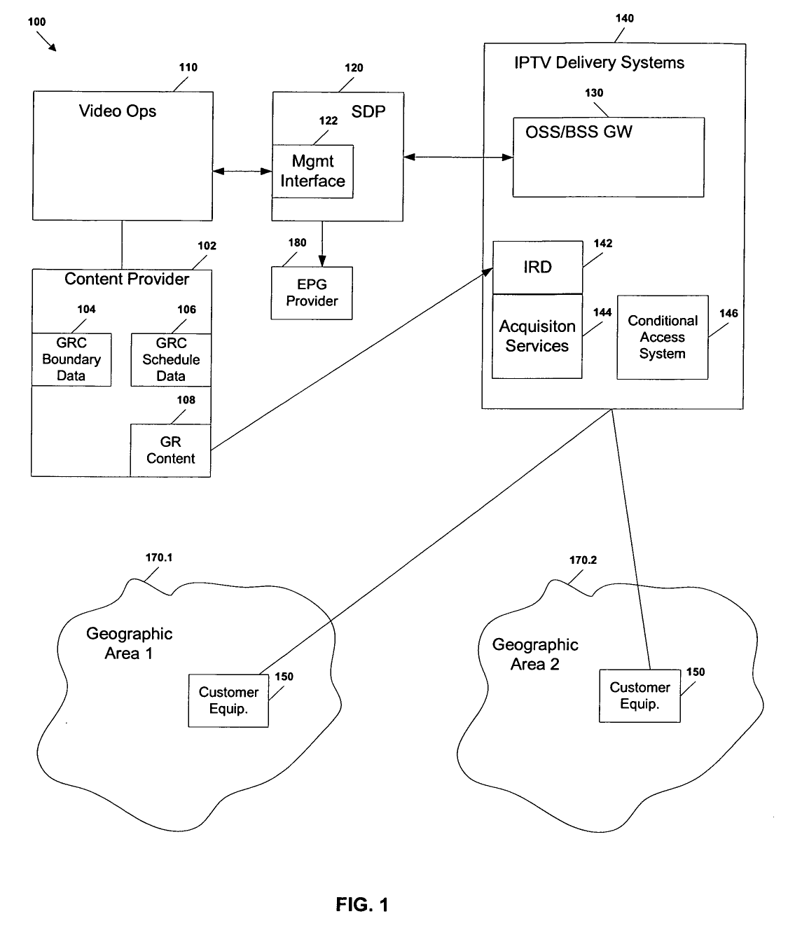

Referring to FIG. 1, an example embodiment of a system 100 for providing geographically restricted content is illustrated. The system 100 may include a content provider 102, a video operations unit 110, a service delivery platform 120 and IPTV delivery systems 140.

Content provider 102 may be any entity that provides content that may need to be geographically restricted. Examples of such content providers include movie or television content providers, sporting event content providers, musical content providers and the like.

In an example embodiment, the content may include media such as video content in the form of a movie or television program and digital music content such as an MP3 file. In an example embodiment, the content may include data such as a video game and/or patch file. In an example embodiment, the content may include informational content. It should be appreciated that other types of content may be used with the system 100.

Content providers 102 may define and maintain GRC (Geographically Restricted Content) boundary data 104 and GRC schedule data 106. In some embodiments, GRC boundary data may be defined in terms of zip codes. For example, 3-digit zip, 5-digit zip, or zip+4 codes may be used. In alternative embodiments, other geographic location mechanisms may be used. For example, the geographical boundaries may be defined in terms of a radius from a center point. The embodiments are not limited to a particular method of defining a geographical boundary.

GRC schedule data 106 comprises a list of blackout events and times for the blackout events.

Video operations unit 110 receives the GRC boundary data 104 and GRC schedule data 106 and uses the data to provide content blackout data to service delivery platform (SDP) 120. Service delivery platform 120 may comprise one or more systems involved with service provisioning, including services related to providing geographically restricted content. In some embodiments, SDP 120 includes a management interface 122 that is used to input content blackout data. In some embodiments, management interface 122 is a graphical user interface. In alternative embodiments, management interface may be a communications interface that receives input data directly from one or more systems.

IPTV system 140 may include various servers and systems involved in the delivery of IPTV services to end users having customer equipment 150 in various geographic areas 170. In some embodiments, IPTV system 140 includes OSS/BSS gateway 130, acquisition services 144, and conditional access module 146.

In some embodiments, the OSS/BSS gateway 130 includes operation systems and support (OSS) data, as well as billing systems and support (BSS) data. In one embodiment, the OSS/BSS gateway can provide or restrict access to an OSS/BSS server that stores operations and billing systems data. SDP 120 forwards blackout event data to OSS/BSS gateway 130 of IPTV system 140. OSS/BSS gateway 130 may store the blackout data and/or forward the blackout data to other systems within IPTV system 140, such as conditional access module 146.

Acquisition services 144 includes one or more systems that receive content from content providers. Acquisition services 144 receives the content through one or more IRDs 142 associated with the content provider. In some embodiments, an IRD (main and backup) is provided at the SHO for each content provider (e.g. ESPN). An additional IRF (main and backup) for each alternate channel required to support the blackout/market protection requirements of the content provider may be used. It should be noted that only one set of one or more IRDs need be used to provide service on a national basis, and that individual IRDs need not be deployed for individual geographic areas 170.

The content may be organized as channels providing services, where a service is a stream of video content. A channel may include one or more services. For example, channel may include a PIP stream and a full screen video stream. A content provider may provide multiple channels, including primary content, secondary content, and one or more channels of substituted content. Primary content is content that may be subject to a blackout event. Secondary content may be content associated with the primary content, such as advertising content related to the primary content. Substituted content is content that may be substituted for the primary content in the event that the primary content is subject to a blackout restriction.

Conditional access module 146 uses the GRC data received by OSS/BSS gateway 130 to determine the content that may be delivered to customer equipment 150 in geographic areas 170.1 and 170.2. As noted above, geographic areas 170.1 and 170.2 may be represented in GRC data as a list of one or more zip codes that are to be included in the geographic area. Conditional access module may be a software component of another IPTV service, or it may be a standalone service within IPTV system 140.

As IPTV system 140 receives requests for content from customer equipment 150, conditional access module 146 determines if the requested content is subject to a blackout for the geographic area where customer equipment 150 exists, based on the GRC data received by OSS/BSS gateway 130. If the requested content is subject to a blackout event based on the blackout schedule and GRC data, conditional access module causes the IPTV system 140 to prevent the requested primary content from being sent to the customer equipment. In this event, IPTV system 140 may be configured to provide an on screen display (OSD) informing the viewer that the primary content is blacked out. The OSD may provide a list of one or more channels of substituted content that may be available. Alternatively, IPTV system 140 may be configured to automatically provide substitute content to the requesting customer equipment 150.

Customer equipment 150 may be any type of equipment capable of receiving IPTV streams. For example, Customer equipment 150 may be a set top box or a computer capable of decoding IPTV streams.

It will be appreciated from the above that a zip code level of granularity in defining a blackout area may be achieved in some embodiments. For example, geographic area 170.1 may be defined as including only one zip code, and geographic area 170.2 may also be defined as including only one zip code. Primary content may be blacked out in geographic area 170.1 while allowed in geographic area 170.2.

In some embodiments, SDP 120 may also provide blackout event data to an EPG (Electronic Program Guide) provider 180. This is desirable, because it provides for the dynamic update of EPG data as blackout events are created, started, and ended.

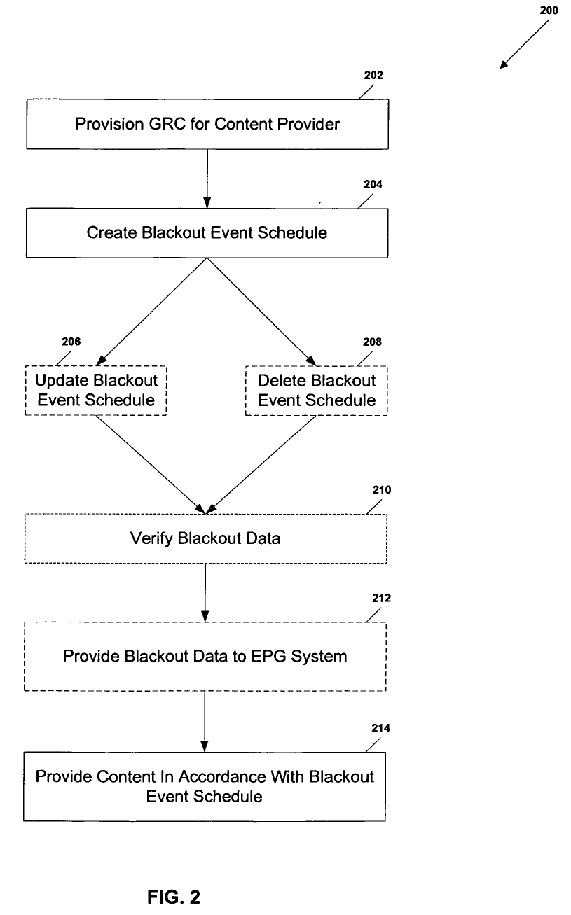

Further details on the operation of system 100 are provided below with reference to FIGS. 2-7.

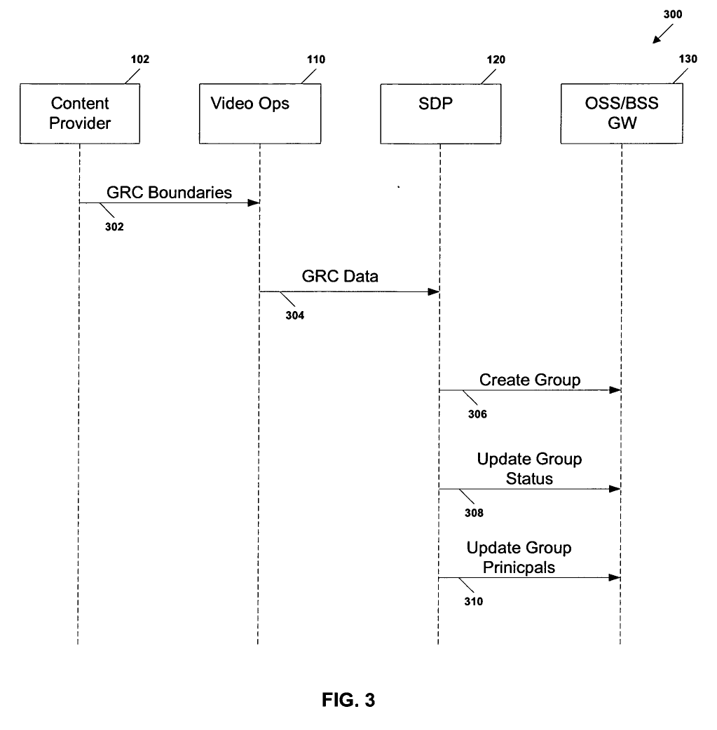

Referring to FIG. 2, a flowchart illustrating a method 200 in accordance with an example embodiment for providing geographically restricted content is shown. The method begins at block 202 by provisioning geographically restricted content for a content provider. In some embodiments, a GRC user interface is used to input data regarding geographically restricted content into a service delivery platform. The data may include boundary data as defined by a content provider. Provisioning GRC for a content provider may include initializing data for a content provider or updating GRC data that has been previously entered. FIG. 3 discussed below is a sequence diagram that provides further details on provisioning GRC data for a content provider.

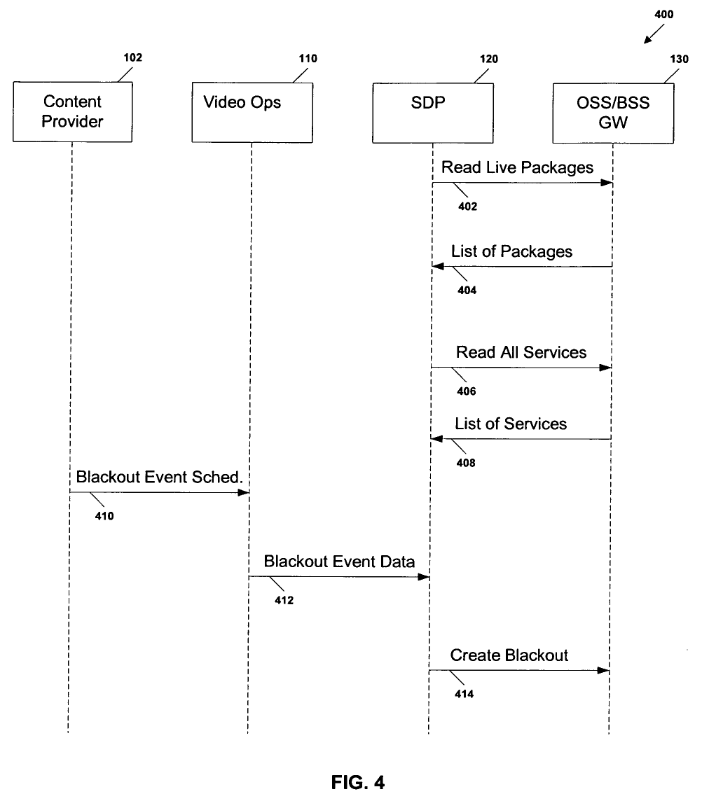

A blackout schedule is created at block 204. The blackout schedule comprises a list of blackout events for a content provider. In some embodiments, SDP 120 reads a list of packages and services for each blackout channel and creates a blackout event data structure describing the blackout event. Further details on creating a blackout schedule are provided by the sequence diagram shown in FIG. 4.

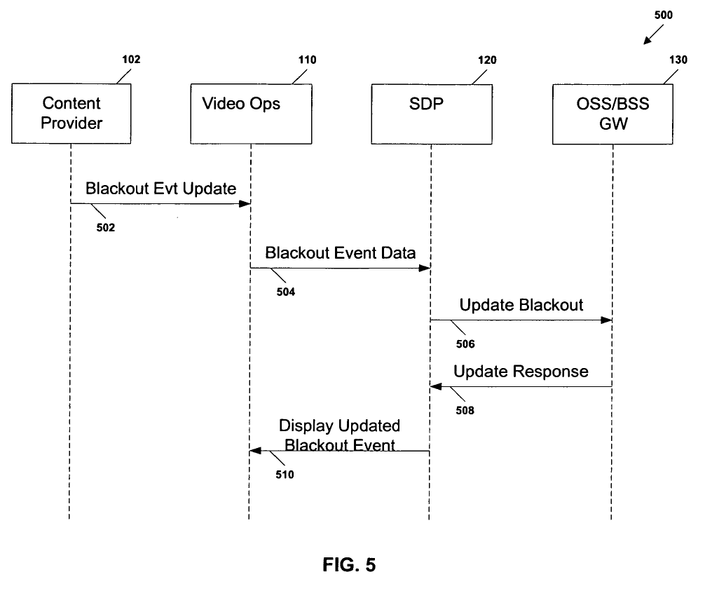

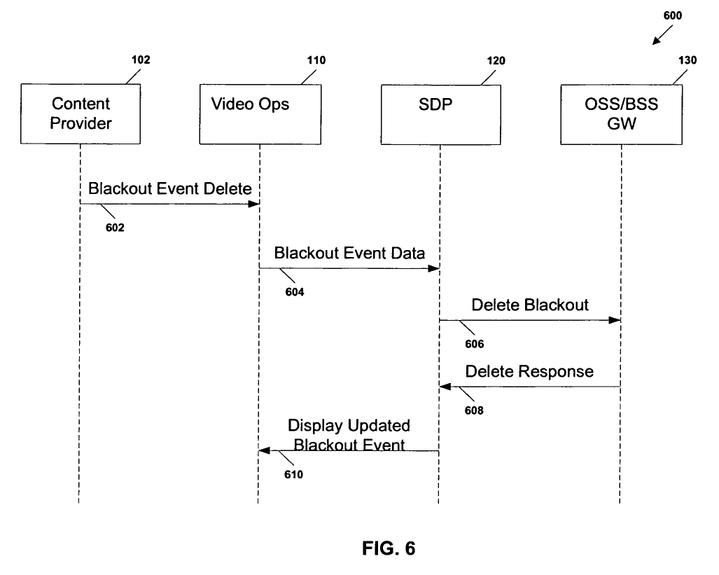

Blocks 206 and 208 represent activities that may optionally take place after a GRC provider has been provisioned at block 202. The activities may include updating a previously created blackout schedule (block 206) or deleting a previously created blackout schedule (block 208), thereby removing a blackout event. Further details on blackout event updates and deletes are provided by the sequence diagrams discussed below with respect to FIGS. 5 and 6 respectively.

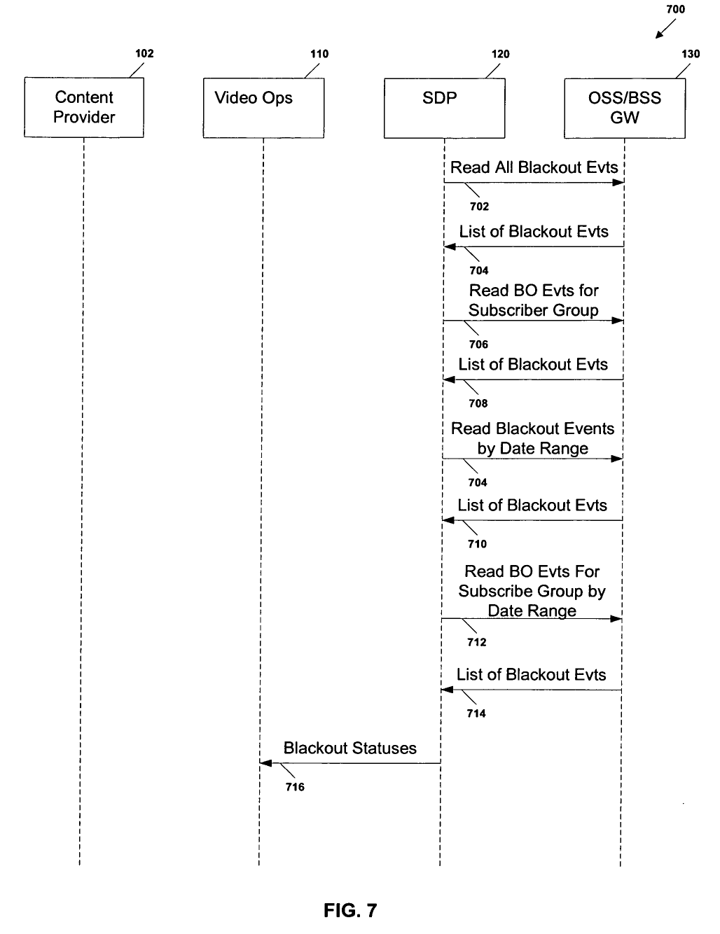

Current blackout event data may optionally be verified at block 210. A user may use interface 122 to query SDP 120 for the current blackout event data. In some embodiments, SDP 120 obtains the current blackout event data from OSS/BSS gateway 130 and presents the current blackout data to the user. The user may use the data to verify the a blackout event has been correctly created, updated or deleted. Further details on verifying blackout event data is provided by the sequence diagram discussed below with respect to FIG. 7.

In some embodiments, at block 212, information regarding blackout events that are created, updated or deleted may be sent to an EPG provider. The EPG provider may use the data to dynamically update an EPG that may be provided to IPTV customers.

At block 214, SDP 120 provides primary and alternative (substitute) content for a blacked out event on one or more channels in accordance with the blackout event schedule and geographic boundaries established at blocks 202-208 above. In some embodiments, the channels may include primary content streams and substitution content streams. In some embodiments, the IPTV system ignores control channel and the embedded conditional access event information embedded within the content streams, because the blackout event data received from SDP 120 is used to determine whether content is subject to a blackout event. The blackout event data is used to instruct IPTV system 140 to switch the appropriate content streams to the appropriate customer equipment within the specified blackout region according to the blackout event data maintained on the SDP and/or OSS/BSS system.

Referring to FIG. 3, a sequence diagram for a method 300 for provisioning geographically restricted content for a content provider in accordance with an example embodiment is shown. In some embodiments, provisioning begins at 302 when a content provider provide list of GRC boundaries. As noted above, the boundary data may be based on 3-digit/5-digit zip/zip+4 boundaries or other geographic location mechanisms.

At 304, For each content provider, video operations unit 110 enters the GRC data into SDP 120 (either manually or in an automated process). In some embodiments, this data includes may include various combinations of one or more of:
GRC ID
GRC Boundaries (3-digit zip, 5-digit zip, zip+4)
Content Provider ID
Optional Team/League
Effective and Expiration Date
Modification Date/Modification By
Approved By

At 306, in some embodiments, SDP 120 additionally creates a persistent GRC data structure containing normalized values for the GRC boundaries. For each content providers' GRC, SDP 120 may create a corresponding subscriber group in IPTV. A subscriber group is a representation of a geographic boundary, and comprises a set of subscribers within the define geographic area. In some embodiments, a subscriber group may include one or more of the following:
Name of Subscriber Group
Status=Enabled/Disabled
Type=Blackout

At 308, a status attribute for the subscriber group may be updated. This may be useful for versioned GRCs.

At 310, a principals list may be updated allowing for the addition and/or removal of accounts/subscribers from subscriber groups. A principal is an account holder that may be responsible for one or more subscribers.

Referring to FIG. 4, a sequence diagram for a method 400 for defining a blackout schedule for geographically restricted content in accordance with an example embodiment is shown. In some embodiments, SDP 120 discovers blackout service collections and the associated services contained in each service collection for each blackout channel provisioned at IPTV. For example, at 402 SDP 120 requests a list of packages from OSS/BSS GW 130. At 404, OSS/BSS GW 130 returns a list of packages which, for each package in the list, may contains various combinations of one or more of:
Package Name
Package ID
Array of Service IDs
Array of Package IDs for recursive package of packages

At 406 SDP 120 requests a list of services from OSS/BSS GW 130. At 408, OSS/BSS GW 130 returns a list of services which, for each service in the list, may contains various combinations of one or more of:
Service Name
Service ID
Full Screen/PiP (defines whether service is provided as a full screen or Picture in Picture service)
Description

At 410, based on information received from content providers, video operations unit 110 uses interface 122 to provision a blackout event. For each content provider, video operations unit 110 will enter into the user interface 122 of SDP 120 the corresponding blackout attributes. In some embodiments, these blackout attributes may include various combinations of one or more of:
Blackout ID
Affected GRC(s) (one or more geographic areas to which blackout should be applied)
Primary Channel
Blackout Content From list of discovered service collection and services from IPTV by SDP
Blackout Type (standard or reverse blackout)
Start Date/Time (In some embodiments, on-demand blackout event execution requires a 5-minute pad time)
End Date/Time
Start Mode (manual or auto)
End Mode (manual or auto)
Alternate Channel and Content* From list of discovered service collection and services from IPTV by SDP
Alert and Alert Mechanism (e.g. pager, phone, email, instant message etc.)

At 412, SDP 120 persists blackout event structures. For each content provider, SDP 120 will create a blackout event in IPTV with the following:
Subscriber Group ID
External Blackout ID (human readable text identifying blackout event)
Start Date/Time
End Date/Time
Primary Main and Primary PiP ID
Secondary Main and Secondary Pip ID
Standard or Reverse Blackout

Referring to FIG. 5, a sequence diagram for a method 500 for updating a blackout schedule for geographically restricted content in accordance with an example embodiment is shown. The sequence begins at 502 when video operations unit receives a request to update a blackout schedule for a content provider.

At 504, for each content provider requesting an update, video operations unit 110 may retrieve or display previously scheduled blackout events with the following attributes to be updated:
Blackout ID
Start Mode
Start Date/Time
End Mode
End Date/Time
Alert Recipients

At 506, SDP 120 may persist the Blackout Event updates. For each content provider, SDP may update the associated blackout event in IPTV with the following:
External Blackout ID
Start Date/Time
End Date/Time
Primary Main and Primary PiP ID
Secondary Main and Secondary Pip ID

At 508, OSS/BSS GW 130 responds with an indication of whether or not the update was successful. At 510, SDP 120 may display the results of the update.

Referring to FIG. 6, a sequence diagram for a method 600 for deleting a blackout schedule for geographically restricted content in accordance with an example embodiment is shown. The sequence begins at 602 when video operations unit 110 receives a request to delete a blackout event for a content provider 102.

At 604, for each content provider requesting blackout event deletion, video operations unit 110 may retrieve data for the currently schedule event and issues a request to SDP 120 to delete the event.

At 606, SDP 120 requests deletion of the blackout event from OSS/BSS GW 130. The blackout event may be deleted according to the blackout ID associated with the event, or according to an external ID associated with the blackout event. At 608, OSS/BSS GW 130 responds with an indication of whether or not the deletion was successful.

Referring to FIG. 7, a sequence diagram for a method 700 for verifying a blackout schedule for geographically restricted content in accordance with an example embodiment is shown. In some embodiments, status of executed blackout events (either the execution of the start or the end) can be verified through the retrieval of the associated blackout event, which should have an updated start status and end status if the blackout event was executed successfully. At 702, SDP 120 requests a list of blackout events. At 704, OSS/BSS GW 130 responds with the requested list.

At 706, SDP 120 requests a list of blackout events for a subscriber group. At 708, OSS/BSS GW 130 responds with the requested list.

At 710, SDP 120 requests a list of blackout events for a given date range. At 712, OSS/BSS GW 130 responds with the requested list.

At 714, SDP 120 requests a list of blackout events by subscriber group for a given data range. At 716 OSS/BSS GW 130 responds with the requested list.

It should be noted that any one of the requests events of 702, 706, 710 or 714 maybe used to request blackout event data.

At 716, SDP 120 provides the blackout statuses to video operations unit 110.

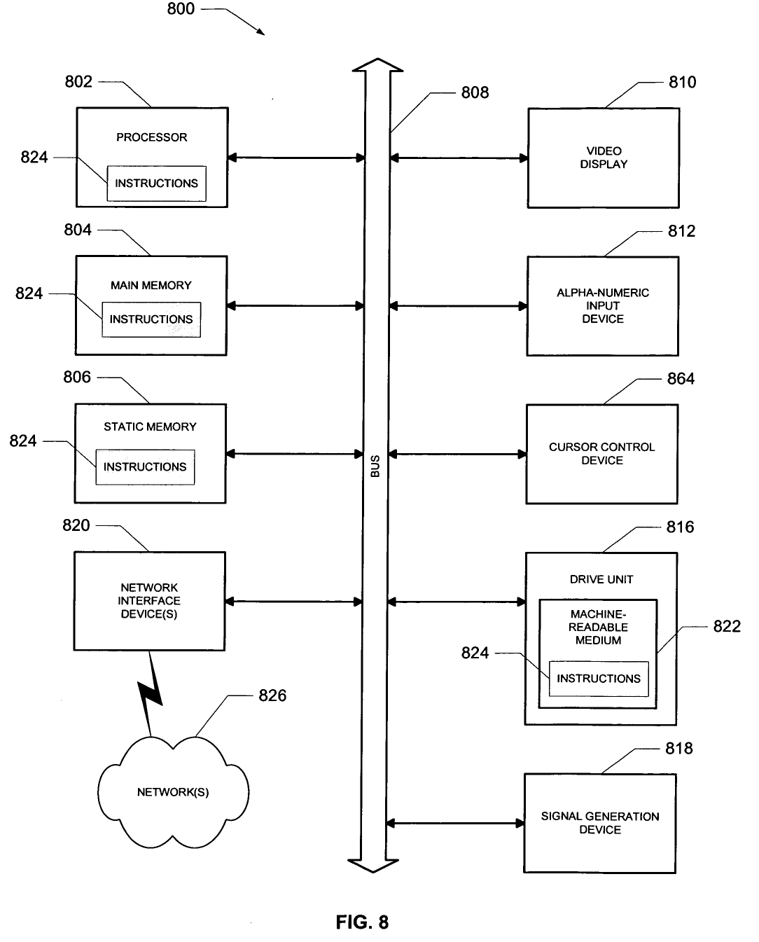

FIG. 8 shows a diagrammatic representation of machine in the example form of a computer system 800 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 812 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation device 814 (e.g., a mouse), a disk drive unit 816 (e.g., a storage), a signal generation device 818 (e.g., a speaker) and a network interface device 820.

The disk drive unit 816 includes a machine-readable medium 822 on which is stored one or more sets of instructions and data structures (e.g., software 824) embodying or utilized by any one or more of the methodologies or functions described herein. The software 824 may also reside, completely or at least partially, within the main memory 804 and/or within the processor 812 during execution thereof by the computer system 800, the main memory 804 and the processor 812 also constituting machine-readable media.

The software 824 may further be transmitted or received over a network 826 via the network interface device 820 utilizing any one of a number of well-known transfer protocols (e.g., HTTP).

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

The systems and methods described above provide for software based switching of primary and substituted content for blackout events that does not use hardware (IRDs) to switch the streams. In some embodiments, the system uses an IRD (main and backup) at the SHO for each channel group (e.g. ESPN+Alternates) required to support the blackout/market protection requirements instead of an IRD per channel group per blackout region as is typical with conventional systems.

Although various embodiments of the present invention have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims.

In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for geographically restricting content, the method comprising:
receiving data representing one or more geographic boundaries;
receiving data representing a blackout event;
receiving content subject to geographic restriction to one or more geographic boundaries; and
determining within a conditional access software module whether a subscriber is within the one or more geographic boundaries according to the data representing one or more geographic boundaries and the data representing the blackout event.

2. The method of claim 1, and further comprising:
providing the content subject to geographic restriction if the subscriber is determined to be not within the one or more geographic boundaries; and
providing alternative content if the subscriber is determined to be within the one or more geographic boundaries.

3. The method of claim 2, wherein the alternative content comprises an on-screen display indicating one or more alternative channels providing substitution content.

4. The method of claim 2, wherein the alternative content comprises substitution content.

5. The method of claim 1, wherein the data representing one or more geographic boundaries includes zip code data.

6. The method of claim 1, further comprising receiving an update to the data representing a blackout event.

7. The method of claim 1, further comprising deleting the data representing the blackout event.

8. The method of claim 1, further comprising:
receiving a request to verify the data representing a blackout event; and
sending the data representing the blackout event in response to the request.

9. The method of claim 1, further comprising sending the data representing a blackout event to an electronic program guide provider.

10. An IPTV (Internet Protocol Television) system comprising:
a service delivery platform operable to receive data representing one or more geographic boundaries and data representing a blackout event;
an acquisition service operable to receive content subject to geographic restriction to one or more geographic boundaries;
a conditional access software module operable to determine whether a subscriber is within the one or more geographic boundaries according to the data representing one or more geographic boundaries and the data representing the blackout event.

11. The system of claim 10, wherein the IPTV system is operable to provide the content subject to geographic restriction if the subscriber is determined to be not within the one or more geographic boundaries and provide alternative content if the subscriber is determined to be within the one or more geographic boundaries.

12. The system of claim 11 wherein the alternative content comprises an on-screen display indicating one or more alternative channels providing substitution content.

13. The system of claim 11, wherein the alternative content comprises substitution content.

14. The system of claim 10, wherein the data representing one or more geographic boundaries includes zip code data.

15. The system of claim 10, wherein the service delivery platform is further operable to send the data representing a blackout event to an electronic program guide provider.

16. A machine-readable medium having machine-executable instructions, that when executed, cause the machine to perform a method, the method comprising:
receiving data representing one or more geographic boundaries;
receiving data representing a blackout event;
receiving content subject to geographic restriction to one or more geographic boundaries; and
determining whether a subscriber is within the one or more geographic boundaries according to the data representing one or more geographic boundaries and the data representing the blackout event.

17. The machine-readable medium of claim 16, wherein the method further comprises:
providing the content subject to geographic restriction if the subscriber is determined to be not within the one or more geographic boundaries; and
providing alternative content if the subscriber is determined to be within the one or more geographic boundaries.

18. The machine-readable medium of claim 16, further comprising receiving an update to the data representing a blackout event.

19. The machine-readable medium of claim 16, further comprising deleting the data representing the blackout event.

20. The machine-readable medium of claim 16, further comprising:
receiving a request to verify the data representing a blackout event; and
sending the data representing the blackout event in response to the request.

21. The machine-readable medium of claim 16, further comprising sending the data representing a blackout event to an electronic program guide provider.
